(19) United States
(12) Patent Application Publication
(10) Pub. No.: US 2003/0038474 A1
(43) Pub. Date: Feb. 27, 2003

(54) Advertising device

(76) Inventor: Mark Thomas Maxted, St. Louis, MO (US)

Correspondence Address: Evan R. Sotiriou, Rudolph A. Telscher, Harness, Dickey & Pierce, P.L.C., Suite 400, 7700 Bonhomme, St. Louis, MO, 63105, US

(21) Appl. No.: 09/940,217

(22) Filed: Aug. 27, 2001

(51) Int. Cl. G09F 1/00

(52) U.S. Cl. 283/56

(57) ABSTRACT

An advertising device and method of providing the same includes permanent advertising content and removable advertising content viewable through a display portion having an opening. One or more display portions, each with one or more openings may be provided. Advertising content to be viewed through the openings, which is capable of easy modification, is provided in a holder or support member of the advertising device. The holder or support member maintains proper positioning of the advertising content for viewing through the openings. Removable advertising content may thereby be provided in a manner such that overall consistency in appearance of the advertising device is maintained.

### FIELD OF THE INVENTION

The present invention relates generally to advertising devices, and more particularly to such a device providing modifiable advertising content in combination with fixed advertising content.

### BACKGROUND OF THE INVENTION

Advertising today typically includes specific content directed to particular consumers, and which is often directed to a specific event, promotion, special, etc. Further, because of the need to change the advertising content (e.g., new specials or promotions), flexibility in advertising devices is important. In particular, advertising relating to retail sales and services requires constant changes resulting from new promotions, specials, job openings, and the like. These changes may occur monthly, but often occur on a day-to-day basis. For example, restaurants typically provide one or more daily specials.

In order to provide effective advertising, the means (e.g., advertising display board) for providing the advertising content not only must set forth in a succinct manner the information of interest, but must be visually appealing, such that consumers are attracted to the advertising. Further, advertising should generally reinforce name branding for the goods or services being advertised. Thus, advertising not only provides specific information relating to, for example, particular events or promotions, but also needs to be visually attractive to consumers.

It is common to provide permanent advertising content (e.g., signs having permanent text thereon, such as hours of operation) and temporary advertising content (e.g., signs having hand-written specials or promotions) separately. This is due in part to the increased cost that would result if, for example, a new sign having permanent text and graphics thereon was created each time temporary advertising content (e.g., daily specials) changed.

As a result, signs have been developed to try to incorporate temporary advertising content with permanent advertising content. Even though these signs display both permanent and temporary advertising content, they are often visually unappealing and difficult or time-consuming to modify. For example, display boards including permanent text (e.g., store name) may include a portion for handwriting or attaching daily specials. Despite best efforts to incorporate the temporary content with the permanent content, these signs are often unappealing because of the perceptible differences (e.g., font, etc) between the two types of content and the means (e.g., staples) used to attach the temporary content. Further, some temporary advertising content may be rotated weekly, thus requiring it to be written once a week or less (e.g., on a chalk board), which is inconvenient.

These known advertising devices for displaying permanent and temporary content also generally allow for easy unauthorized modification of the temporary content (e.g., easily erased or removed from a holder). Further, the advertising devices include holders and other devices that make it obvious even to the casual observer that a portion of the advertising content is temporary, which is visually unappealing. These advertising devices also are often complex in design and difficult to modify because of the various members (e.g., connectors) needed to maintain proper display of the temporary content.

Thus, there exists a need for an advertising device that is capable of displaying both permanent and temporary content in a manner that looks better than prior efforts, is easier to use and less expensive to manufacture. Further, it is desirable for such a device to be capable of easy modification of the temporary content.

### SUMMARY OF THE INVENTION

The present invention provides an advertising device and method of providing the same that is visually appealing while displaying both permanent and temporary advertising content. Modification of the temporary advertising content is easy and provides an overall appearance wherein such temporary advertising content is incorporated without diminishing the aesthetics of the advertising display.

Generally, a permanent portion and a display portion for displaying temporary or modifiable advertising content are provided as part of an advertising device. The permanent portion may include, for example, preprinted graphics or text, or similar content. The display portion includes one or more openings for viewing removable advertising content (i.e., temporary or modifiable advertising content). The openings may include transparent members that may be permanently or removably connected to the advertising device, and are generally substantially planar to a front surface of the advertising device.

A holder or support member for holding the removable advertising content is preferably provided on a back portion of the advertising device in connection with each of the openings. This provides for maintaining the position of the removable advertising content for proper viewing through the openings. The holder or support member includes receiving means, such as an opening for receiving the removable advertising content. A cover may be provided for covering the receiving means to thereby conceal the removable advertising content on the back portion of the advertising device within the holder or support member.

The removable advertising content may include user created advertising content, such as, for example, user created graphics and text, and may be provided on a modifiable member (e.g., small erasable white-board) for removable insertion into the holder or support member. Further, the permanent portion may generally encompass a larger area of the advertising device than the display portion, or vice versa.

A method of the present invention provides permanent advertising content for display on an advertising device along with configuring a portion of the advertising device for viewing removable advertising content through an opening of the advertising device. The opening may include a transparent member that is provided generally planar to a front surface of the advertising device. Means for holding the removable advertising content for proper viewing through the opening may also be included.

Another method of the present invention provides for displaying permanent printed advertising content relating to business information in combination with temporary advertising content relating to services or products of the business. The method further includes displaying the temporary advertising content in a sleeve for viewing through an opening of a display member. A transparent member may also be provided in connection with the opening.

Thus, the present invention provides an advertising device and method of providing the same that includes both permanent and temporary advertising content in a visually appealing manner, and wherein the temporary advertising content is easy to modify. User created content is thereby easily displayed in connection with permanent advertising content.

Further areas of applicability of the present invention will become apparent from the detailed description provided hereinafter. It should be understood that the detailed description and specific examples, while indicating the preferred embodiments of the invention, are intended for purposes of illustration only and are not intended to limit the scope of the invention.

### BRIEF DESCRIPTION OF THE DRAWINGS

The present invention will become more fully understood from the detailed description and the accompanying drawings, wherein:

FIG. 1 is a front elevation view of an advertising device constructed according to the principles of the present invention;

FIG. 2 is a perspective view of a back surface of an advertising device of the present invention;

FIG. 3 is a side elevation view of an advertising device of the present invention;

FIG. 4 is a front elevation view of another exemplary construction of an advertising device of the present invention; and

FIG. 5 is a front elevation view of a further exemplary construction of an advertising device of the present invention with preprinted text thereon.

### DETAILED DESCRIPTION OF THE PREFERRED EMBODIMENTS

The following description of the preferred embodiments is merely exemplary in nature and is in no way intended to limit the invention, its application, or uses. Thus, although the application of the present invention as disclosed herein is generally directed to an advertising device constructed with specific component parts configured in a particular manner, it is not so limited, and different component parts may be provided and configured as desired or needed. It should be understood that as used herein, advertising content is not limited to information relating to the sale of goods and services, but includes, for example, directional information (e.g., the meeting to be held in room 458), emergency or warning information (e.g., elevator is out of service) or greeting and salutary information (e.g., congratulations to salesperson of the month).

Generally an advertising device constructed according to the principles of the present invention and method of providing the same allows for easy modification of a portion of the advertising content while maintaining overall consistency in appearance. Advertising content is thereby customizable by a user (i.e., temporary advertising content), with a portion of the advertising content also provided in a permanent manner.

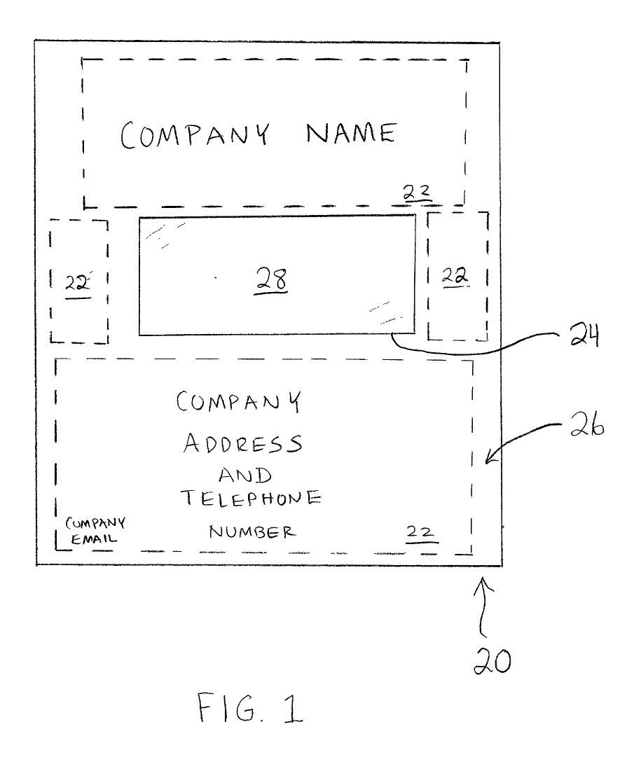

Specifically, and as shown in FIG. 1, an advertising device constructed according to the principles of the present invention is indicated generally therein by reference numeral 20. The advertising device 20 generally includes one or more permanent portions 22 for providing permanent advertising content (e.g., company identifying information, such as company name), and at least one display portion 24 for displaying removable advertising content (i.e., temporary or modifiable advertising content). The permanent portions 22 and display portion 24 together are provided on a front surface 26 of the advertising device 20. As shown in FIG. 1, the advertising device 20 is provided in an exemplary rectangular form. It should be noted that the advertising device 20 may be provided in other shapes and sizes as desired or needed. Further, the advertising device 20 may be constructed of any suitable material, including, for example, plastic, plastic composite, metal or wood.

The one or more permanent portions 22 generally include advertising content, such as, for example, text, graphics, etc. The advertising content may be provided as an integrated part of the front surface 26 (e.g., preprinted or etched) or attached in any suitable manner, such that the advertising content is not easily removed or modified (e.g., using glue). It should be noted that the permanent portions 22 are not limited to the areas as shown in FIG. 1, but may be modified and provided in any location on the front surface 26 of the advertising device 20.

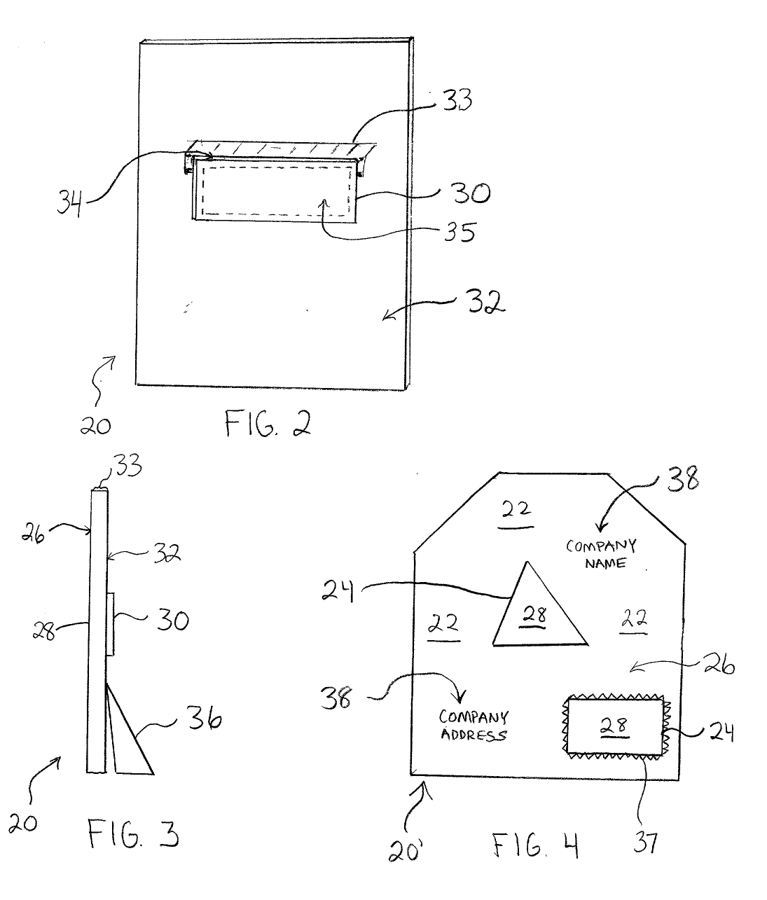

The display portion 24 preferably includes an opening 28 for viewing removable advertising content (i.e., modifiable or temporary advertising content). The removable advertising content is preferably provided within holder or support member 30 provided on a back surface 32 of the advertising device 20 as shown in FIG. 2. As shown therein, the holder or support member 30 may be provided as a pocket or sleeve for supporting the removable advertising content.

However, it should be noted that other means for holding and supporting the removable advertising content are contemplated. For example, a slit or other similar member or structure may be provided for inserting the removable advertising content therein for viewing through the opening 28. The slit may be provided on a side, top, or bottom of the advertising device 20. Further, connection of the holder or support member 30 to the back surface 32 may be provided in any suitable manner, including, for example, using permanent adhesive.

The holder or support member 30 is constructed such that it corresponds to the opening 28, with the advertising content provided therein maintained in proper position for viewing through the opening 28. Essentially, the holder or support member 30 has substantially the same dimensions as the opening 28. More preferably, the holder or support member 30 is dimensionally slightly larger than the opening 28 to accommodate advertising content with a border or margins, or similar regions having no advertising content thereon.

A cover 33 attached to the holder or support member 30 may be provided to conceal the advertising content therein. The cover 33 may be constructed of any suitable rigid or flexible material depending upon the particular application. Preferably, the cover 33 conceals a receiving means 34 (i.e., an opening) of the holder or support member 30 when in a closed position. In an open position, access is provided to the receiving means 34 through which the advertising content is inserted and removed.

The advertising content provided within the holder or support member 30 generally includes user created content. For example, a sheet of paper 35 or similar member having typed content thereon may be inserted within the holder or support member 30 for viewing through the opening 28. The advertising content provided within the holder or support member 30 may be replaced as often as desired or necessary (e.g., weekly). Alternately, the advertising content within the holder or support member 30 may be modified (i.e., removed, revised and then inserted again). This modification process includes revising the content, such as, for example, by erasing certain content and replacing with new content (e.g. providing new specials).

A transparent member, such as, for example, a plastic insert may be provided in connection with the opening 28. The transparent member may be constructed, for example, of either a rigid or flexible material as desired. In one exemplary construction, the transparent member may be constructed as an integral part of the advertising device 20 at the opening 28. In this construction, the transparent member is preferably provided as a rigid material. In an alternate exemplary construction, the transparent member may be removably connected to the advertising device 20 using, for example, a Velcro® type fastener or complimentary magnets, or may be adapted for sliding into the opening. In this construction, different types of transparent members 28 (e.g., different colors) may be removably connected to the advertising device 20 and are preferably provided as a flexible material.

As shown in FIG. 3, the opening 28 with a transparent member therein is generally planar to the front surface 26 of the advertising device 20, thereby providing a consistent appearance between the permanent portions 22 and the removable advertising content viewed through the opening 28. A base member 36 (e.g., a stand) or other suitable device may be provided on the back surface 32 of the advertising device 20 to support the advertising device 20 in a fixed position (e.g., substantially vertical). It should be noted that depending upon the configuration of the advertising content, the base member 36 may be provided on any portion of the back surface 32, such that the advertising device 20 may be supported in either a vertical or horizontal manner. Further, a hanging device or similar member (e.g., picture hanger or suction cup with hanger) may be provided to hang the advertising device 20 from a supporting structure (e.g., a wall or window).

It should also be noted that the advertising device 20 is preferably constructed with a substantially thin profile 33 (e.g., less than about one inch). Generally, the profile 33 is substantially less than either the height or width of the advertising device 20. However, depending upon the particular application, the profile 33 may be constructed thicker.

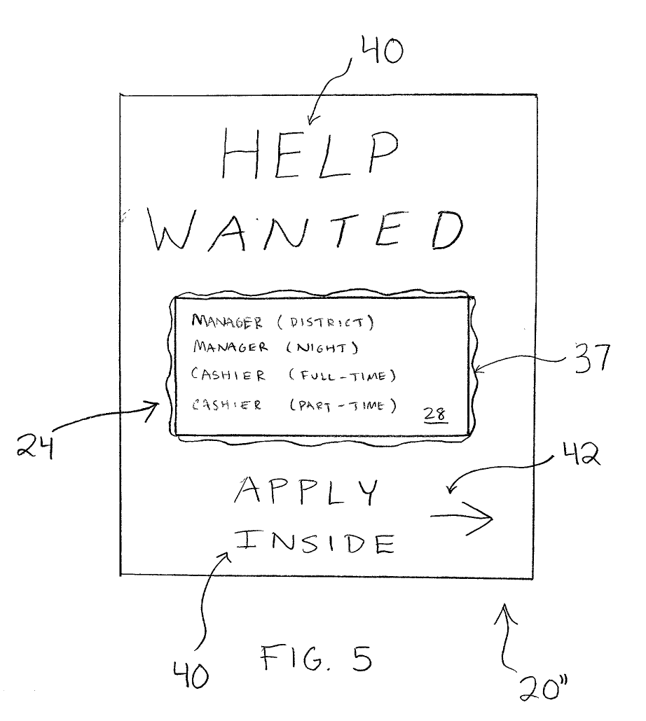

An advertising device 20 constructed according to the principles of the present invention is not limited to a particular configuration having a specific shape or size, with a specific number of permanent portions 22, display portions 24 and openings 28. For example, a display portion 24 may include more than one opening 28 or a plurality of display portions 24 may be provided each with a single opening 28. Thus, alternate embodiments may be constructed. For example, and as shown in FIG. 4, an advertising device 20′ includes permanent advertising content 38 (e.g., preprinted text) on the permanent portions 22 of the front surface 26 of the advertising device 20′. A plurality of display portions 24 each having a opening 28 is provided in different shapes and sizes on the front surface 26 of the advertising device 20′. It should be noted that the display portions 24 may include permanent designs 37, graphics or other effects as shown in FIGS. 4 and 5. Further, it should be noted that a holder or support member 30 corresponding to each of the openings 28 is preferably provided on a back surface 32 of the advertising device 20′ in this embodiment.

Referring now to FIG. 5, and another exemplary advertising device 20″ for use in, for example, a retail store, such as a restaurant, preprinted text 40 (i.e., HELP WANTED and APPLY WITHIN) and graphics 42 are provided as part of the permanent portions 22 of the advertising device 20″. It should be noted that permanent designs 37 also are provided as part of the display portion 24. An opening 28 is provided as part of the display portion 24 for viewing removable advertising content within the holder or support member 30, which advertising content in connection with this exemplary embodiment of the advertising device 20″, may include, for example, different available job openings and positions. In operation, as positions are filled, or others become available, the removable advertising content displayed through the opening 28 may be changed. For example, a page of typed job openings may be provided within the holder or support member 30 and replaced with an updated page at predetermined time intervals (e.g., weekly).

Thus, in operation, removable advertising content is inserted within the holder or support member 30 of the advertising device 20 for viewing through the opening 28 of the display portion 24. The overall appearance of the advertising device 20 is consistent (i.e., no visible separation between the permanent and removable advertising content), with the removable advertising content provided within the holder or support member 30 easily replaced or modified. The permanent portion(s) 22 accommodate advertising content that remains constant over longer periods of time (e.g., company name), while the display portions 24 provide for viewing advertising content that requires modification (e.g., daily specials).

Although the present invention has been described in connection with advertising devices having specific configurations with various portions providing permanent and removable advertising content, it is not so limited, and an advertising device of the present invention may be constructed in different configurations and having different or additional portions. For example, the shape and size of the advertising device may be modified as desired or needed. Further, additional openings or ones having different shapes and sizes may also be provided.

The description of the invention is merely exemplary in nature and, thus, variations that do not depart from the gist of the invention are intended to be within the scope of the invention. Such variations are not to be regarded as a departure from the spirit and scope of the invention as claimed.

What is claimed is:

1. A device for use in advertising, the device comprising:
a front surface for providing advertising content;
a permanent portion on the front surface having permanent advertising content thereon;
at least one display portion on the front surface having an opening for viewing removable advertising content; and
a support member adapted for maintaining the position of the removable advertising content for viewing through the opening of the display portion.

2. The device according to claim 1 further comprising a back surface and wherein the support member is connected to the back surface.

3. The device according to claim 1 wherein the display portion comprises a transparent member at the opening.

4. The device according to claim 2 wherein the support member comprises a pocket that is adapted for maintaining the position of the removable advertising content provided therein for viewing through the opening.

5. The device according to claim 2 wherein the support member comprises a receiving means for receiving the removable advertising content therein.

6. The device according to claim 5 wherein the support member further comprises a cover member for covering the receiving means and concealing the removable advertising content therein.

7. The device according to claim 1 wherein the permanent advertising content is preprinted on the front surface.

8. The device according to claim 1 wherein the permanent portion encompasses a substantially larger area of the front surface than the display portion.

9. The device according to claim 1 wherein the display portion encompasses a substantially larger area of the front surface than the permanent portion.

10. The device according to claim 3 wherein the transparent member is permanently connected to the front surface.

11. The device according to claim 10 wherein the transparent member is substantially planar to the front surface.

12. The device according to claim 3 wherein the transparent member is adapted for removable connection to the front surface.

13. An improved advertising device comprising:
a front surface having permanent advertising content thereon;
a back surface in combination with the front surface forming a substantially thin profile;
support means adapted for holding the place of removable advertising content; and
at least one opening on the front surface for viewing the removable advertising content.

14. The improved advertising device according to claim 13 further comprising a transparent member at the opening.

15. The improved advertising device according to claim 14 further comprising a base member for supporting the improved advertising device in a desired position.

16. An improved method of advertising, the improved method comprising the steps of:
providing permanent advertising content for display using an advertising device; and
configuring a portion of the advertising device for viewing removable advertising content through an opening on a front surface of the advertising device.

17. The method according to claim 16 further comprising providing a support member on a back surface of the advertising device to support the removable advertising content for viewing through the opening.

18. A method of advertising, the method comprising the steps of:
displaying permanent printed advertising content relating to company identifying information on a displayable advertising device; and
displaying temporary advertising content relating to services or products of the company on the displayable advertising device.

19. The method according to claim 18 further comprising providing an opening on the displayable advertising device for viewing the temporary advertising content.

20. The method according to claim 19 further comprising inserting the temporary advertising in a sleeve on a back surface of the displayable advertising device for viewing through the opening having a transparent member connected thereto.
